(19) United States
(12) Patent Application Publication
(10) Pub. No.: US 2010/0148560 A1
(43) Pub. Date: Jun. 17, 2010

(54) HEAD SUPPORT STRUCTURE

(76) Inventor: Sean MacPherson, Ronkonkoma, NY (US)

Correspondence Address: JAY M. SCHLOFF, 6960 Orchard Lake Road, Suite 315, West Bloomfield, MI, 48322, US

(21) Appl. No.: 12/482,809

(22) Filed: Jun. 11, 2009

Related U.S. Application Data
(60) Provisional application No. 61/113,895, filed on Nov. 12, 2008.

(51) Int. Cl. B60N 2/48

(52) U.S. Cl. 297/397

(57) ABSTRACT

A head support structure for providing support to a user seated in a vehicle. The head support structure includes a base, a head support platform and a pair of cushioned members. The base is disposed on a backrest of a seat of the vehicle. A back surface of the head support platform is coupled to a front surface of the base through hook and loop fasteners. The pair of cushioned members is attached on the front surface of the head support platform. The pair of cushioned members is configured to support a head of the user seated on the seat. The hook and loop fasteners are capable of coupling the head support platform to the base in one or more positions. A position of the one or more positions enables placement of the head of the user between the pair of cushioned members of the head support platform.

### CROSS REFERENCE TO RELATED APPLICATIONS

The present disclosure claims priority under 35 United States Code, Section 119 on the U.S. Provisional Patent Application No. 61/113,895 filed on Nov. 12, 2008, the disclosure of which is incorporated by reference.

### FIELD OF THE DISCLOSURE

The present disclosure relates generally to head support structures, and, more particularly, to a head support structure utilized in a vehicle.

### BACKGROUND OF THE DISCLOSURE

Typically, in a vehicle, such as a car, a boat, an airplane, and the like, seats are provided for passengers of the vehicle to be seated. A seat may have a backrest attached thereto to support a back and a head of a passenger seated on the seat. Further, a headrest may be coupled to the backrest to provide additional support to the head of the passenger.

The passenger may need to sit in the vehicle for long hours during journeys. The passenger, especially a child, may fall asleep while being seated for a long duration in the vehicle. More specifically, during overnight journeys the passenger may tend to sleep in the vehicle. Typically, the passenger's head may sag or hang unsupported while the passenger is asleep. The sagging of the passenger's head may strain his or her neck muscles. Further, there may be a possibility of the passenger's head hitting an interior surface of the vehicle, such as an arm rest, a utility tray, and the like. Furthermore, the hanging or the sagging of the passenger's head may cause discomfort to the passenger. Still further, in case of a child, there may be a possibility that a seat belt worn by the child may grip or sit across the child's neck or the child's face, thereby posing a risk to the child.

Currently, a few solutions exist for addressing these problems. A head support unit may be connected to a seat of a vehicle for supporting the passenger's head. The head support unit is connected to the headrest of the seat and includes a convex-shaped roll. The convex-shaped roll supports the passenger's head within a depression formed within the convex-shaped roll. The convex-shaped roll prevents the passenger's head from sagging.

However, the head support unit mentioned above may not be adjustable. More specifically, the head support unit may be affixed to the seat of the vehicle at a particular position and may not be usable by different passengers of varying heights. Still further, the position at which the head support unit is affixed to the seat may not permit the passenger to shift on the seat, thereby causing discomfort to the passenger.

In light of the drawbacks mentioned above, there is a need for preventing a passenger's head from sagging when the passenger is seated in a seat of a vehicle. Further, there is a need for supporting a head of a passenger according to a height of the passenger. Still further, there is a need for supporting a head of a passenger in a position that is comfortable for the passenger.

### SUMMARY

In view of the foregoing disadvantages inherent in the prior art, the general purpose of the present disclosure is to provide a head support structure for providing support to a user seated in a vehicle, configured to include all the advantages of the prior art, and to overcome the drawbacks inherent therein.

Accordingly, an object of the present disclosure is to provide a head support structure that prevents a user's head from sagging when the user is seated in a seat of a vehicle.

Another object of the present disclosure is to provide a head support structure that supports a head of a user based on a height of the user.

Yet another object of the present disclosure is to provide a head support structure that supports a head of a user in a position that is comfortable for the user.

In light of the above objects, in one aspect of the present disclosure, a head support structure for giving support to a user seated in a vehicle, is provided. The head support structure includes a base, a head support platform and a pair of cushioned members. The base is disposed on a backrest of a seat of the vehicle. The head support platform includes a back surface and a front surface. The back surface of the head support platform is coupled to a front surface of the base through hook and loop fasteners. The pair of cushioned members is attached on the front surface of the head support platform. The pair of cushioned members is configured to support a head of the user seated on the seat. The hook and loop fasteners are capable of coupling the head support platform to the base in one or more positions. A position of the one or more positions enables placement of the head of the user between the pair of cushioned members of the head support platform.

This together with other aspects of the present disclosure, along with the various features of novelty that characterize the present disclosure, are pointed out with particularity in the claims annexed hereto and form a part of this present disclosure. For a better understanding of the present disclosure, its operating advantages, and the specific objects attained by its uses, reference should be made to the accompanying drawing and descriptive matter in which there are illustrated exemplary embodiments of the present disclosure.

### BRIEF DESCRIPTION OF THE DRAWINGS

The advantages and features of the present disclosure will become better understood with reference to the following detailed description and claims taken in conjunction with the accompanying drawings, wherein like elements are identified with like symbols, and in which:

FIG. 1 illustrates a perspective view of a head support structure placed on a seat of a vehicle, for providing support to a head of a user seated on the seat, in accordance with an embodiment of the present disclosure.

FIG. 2 illustrates an exploded view of the head support structure, in accordance with an embodiment of the present disclosure.

Like reference numerals refer to like parts throughout the description of several views of the drawings.

### DETAILED DESCRIPTION OF THE DISCLOSURE

The exemplary embodiments described herein detail for illustrative purposes are subject to many variations in composition, structure, and design. It should be emphasized, however, that the present disclosure is not limited to a particular head support structure for providing support to a user seated in a vehicle, as shown and described. It is understood that various omissions and substitutions of equivalents are contemplated as circumstances may suggest or render expedient, but these are intended to cover the application or implementation without departing from the spirit or scope of the claims of the present disclosure. Also, it is to be understood that the phraseology and terminology used herein is for the purpose of description and should not be regarded as limiting.

The terms “a” and “an” herein do not denote a limitation of quantity, but rather denote the presence of at least one of the referenced items.

The present disclosure provides a head support structure for providing support to a user seated in a vehicle. Specifically, the head support structure may be utilized to support a head of the user seated in the vehicle. Examples of the vehicle may include a car, a train, a boat, an airplane, a spacecraft, and the like. The head support structure may prevent the head of the user from sagging when the user is sleeping in the vehicle. Further, the head support structure may support the head of the user, such as a child, seated in the seat of the vehicle, thereby preventing the head of the child from sagging when the child sleeps. Furthermore, the head support structure may be capable of being adjusted for providing support to users of varying heights. It will be apparent to a person skilled in the art that the head support structure may not be limited to being utilized in seats of vehicles, and may be utilized on a variety of seats.

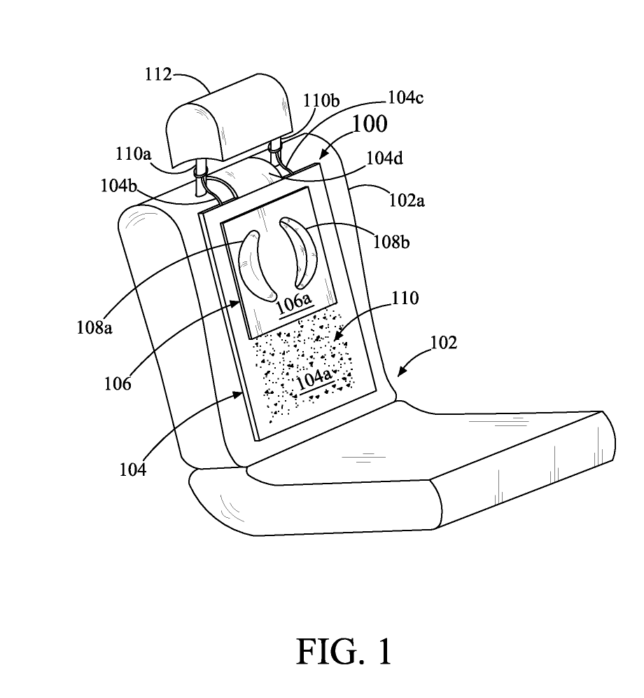

FIG. 1 illustrates a perspective view of a head support structure 100 deployed on a seat 102 of a vehicle (not shown) for providing support to a head of a user (not shown) seated on the seat 102, in accordance with an embodiment of the present disclosure. Examples of the vehicle may include a car, a boat, an airplane, a spacecraft, and the like. The head support structure 100 includes a base 104, a pair of strings, such as a string 104b and a string 104c, a coupling member 104d, a head support platform 106 and a pair of cushioned members, such as a cushioned member 108a and a cushioned member 108b. Hereinafter, the pair of cushioned members will collectively be referred to as ‘pair of cushioned members 108’. The seat 102 includes a backrest 102a, a headrest 112, a pair of supporting members, such as a supporting member 110a and a supporting member 110b.

The base 104 is disposed on the backrest 102a of the seat 102 of the vehicle and includes a front surface 104a. The head support platform 106 includes a back surface (not shown) and a front surface 106a. The back surface of the head support platform 106 is coupled to the front surface 104a of the base 104 through hook and loop fasteners (hook fasteners, such as a hook fastener 110, are shown in FIG. 1, loop fasteners are not shown in FIG. 1). The pair of cushioned members 108 is attached on the front surface 106a of the head support platform 106. The pair of cushioned members 108 is configured to support the head of the user seated on the seat 102. The hook fasteners and the loop fasteners are capable of coupling the head support platform 106 to the base 104 in one or more positions. A position of the one or more positions enables placement of the head of the user between the pair of cushioned members 108 of the head support platform 106.

Referring to FIG. 1, the base 104 is disposed on the backrest 102a of the seat 102 of the vehicle. In an embodiment of the present disclosure, the base 104 is disposed on the backrest 102a through the pair of supporting members (that is configured to couple the headrest 112 with the backrest 102a). Specifically, the pair of strings of the base 104 couple with the pair of supporting members of the seat 102 through a snap and hook arrangement. In other embodiments of the present disclosure, coupling mechanisms, such as clips, buttons, buckles, and combinations thereof may be utilized, instead of the pair of strings, to dispose the base 104 on the backrest 102a.

The base 104 includes the coupling member 104d configured to additionally couple the base 104 with the seat 102. The coupling member 104d may be a composed of at least one of cotton, nylon, polyester and the like. The coupling member 104d may include clips, strings, buttons, buckles, and various combinations thereof to couple the base 104 with the seat 102. It may be apparent to a person skilled in the art that the base 104 may be coupled to the seat 102 using various other coupling techniques.

The base 104 may be composed of at least one of cotton, nylon, polyester and leather. Further, in an embodiment of the present disclosure, the base 104 may be rectangular in shape with a length dimension of about 12 inches and a breadth dimension of about 10 inches. It may be apparent to a person skilled in the art that the base 104 may be of various shapes and dimensions and may be composed of a variety of materials.

The head support platform 106 includes a front surface 106a and a back surface (not shown). The back surface of the head support platform 106 is coupled to the front surface 104a of the base 104 through the hook fasteners and the loop fasteners. In an embodiment of the present disclosure, the head support platform 106 may be square in shape with each side having a dimension of about 10 inches. It may be apparent to a person skilled in the art that the head support platform 106 may have different shapes and dimensions. The head support platform 106 supports the pair of cushioned members 108.

The pair of cushioned members 108 extends outwardly from the front surface 106a of the head support platform 106. The pair of cushioned members 108 may be attached to the front surface 106a of the head support platform 106 through stitches, adhesive glue, and the like. The pair of cushioned members 108 is configured to support the head of the user seated in the vehicle. The pair of cushioned members 108 may be shaped and attached to the head support structure 106 such that the head of the user may be accommodated therebetween. As shown in FIG. 1, the cushioned member 108a and the cushioned member 108b are crescent shaped to accommodate the head of the user therebetween. In an embodiment of the present disclosure, a height of each cushioned member of the pair of cushioned members 108 is in a range of about 2 to 3 inches.

In an embodiment of the present disclosure, the cushioned member 108a and the cushioned member 108b may be cylindrical in shape. Each of the pair of cushioned members 108 may have a diameter of a base of the cylinder of about 3 inches and length of the cylinder of about 6 inches. It will be apparent to a person skilled in the art that various shapes, positions and sizes of the pair of cushioned members 108 may exist without departing from scope of the present disclosure. In an embodiment of the present disclosure, the pair of cushioned members 108 is made up of a soft and flexible material so as to avoid discomfort or injury to the user. For example, the pair of cushioned members 108 may have an outer covering made up of a soft and flexible material, such as, leather, cotton, polyester, and the like, that may be comfortable for the user. Further, the pair of cushioned members 108 may be stuffed with a soft material, such as cotton, sponge, and the like, to provide comfort to the user. It may be apparent to a person skilled in the art that various other materials may be used for the outer covering and as stuffing.

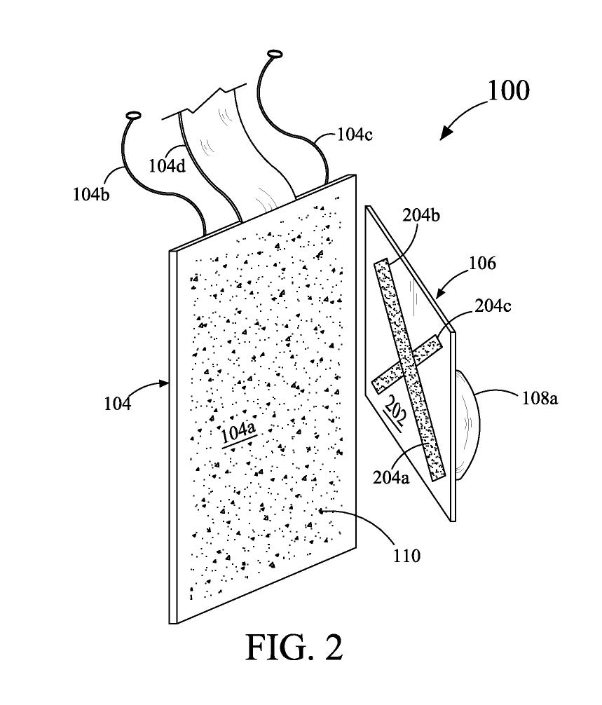

As disclosed earlier, the back surface of the head support platform 106 is coupled to the front surface 104a of the base 104 through the hook fasteners and the loop fasteners. The coupling of the head support platform 106 with the base 104 through the hook fasteners and the loop fasteners will be explained in conjunction with FIG. 2.

FIG. 2 illustrates an exploded view of the head support structure 100 of FIG. 1, in accordance with an embodiment of the present disclosure. The head support platform 106 of the head support structure 100 includes the front surface 106a (shown in FIG. 1) and a back surface 202. The back surface 202 of the head support platform 106 is coupled to the front surface 104a of the base 104 through the hook fasteners, such as the hook fastener 110, and the loop fasteners, such as a loop fastener 204a. Specifically, the back surface 202 includes one or more portions, such as a portion 204b and a portion 204c, of the loop fasteners, as shown in FIG. 2. In an embodiment of the present disclosure, the back surface 202 of the head support platform 106 may include at least one of the hook fasteners and the loop fasteners. Accordingly, the front surface 104a of the base 104 may include complementary loop fasteners and complementary hook fasteners to couple the base 104 with the head support platform 106. For example, if the front surface 104a of the base 104 includes the hook fasteners then the back surface 202 of the head support platform 106 includes the loop fasteners, and vice-versa. It will be apparent to a person skilled in the art that the hook fasteners and the loop fasteners may be arranged in a variety of ways on the base 104 and the head support platform 106.

The arrangement of the hook fasteners and the loop fasteners provides one or more positions in which the head support platform 106 may be placed on the base 104. An exemplary placement of the head support platform 106 on the base 104 is depicted in FIG. 1. It will be apparent to a person skilled in the art that the head support platform 106 may be coupled to the base 104 in various positions and orientations.

The head support platform 106 is coupled with the base 104 at a predetermined position of the one or more positions for providing support to the head of the user. The predetermined position may be determined based on a height of the user. The pre-determined position may enable placement of the head of the user between the pair of cushioned members 108 of the head support platform 106.

A head support structure, such as the head support structure 100, for providing support to a user seated in a vehicle is advantageous for preventing sagging of the user's head. Specifically, the head support structure is beneficial in preventing the user's head from sagging when the user is sleeping in the vehicle. Further, the head support structure prevents strain on neck muscles of the user due to sagging of the user's head. Furthermore, the head support structure reduces risk of a potential injury to the user due to movement of the vehicle when the user's head is sagging.

Still further, hook fasteners and loop fasteners of the head support structure enable the user to adjust the head support structure according to a requirement of the user. The head support structure enables the user to shift in a seat of the vehicle and adjust the head support platform accordingly. Specifically, the user is enabled to change a position of the head support platform. Further, the user is also enabled to orient the head support platform.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present disclosure.

What is claimed is:

1. A head support structure for providing support to a user seated in a vehicle, the head support structure comprising:
a base disposed on a backrest of a seat of the vehicle;
a head support platform comprising a back surface and a front surface, the back surface of the head support platform coupled to a front surface of the base through hook and loop fasteners; and
a pair of cushioned members attached on the front surface of the head support platform, the pair of cushioned members configured to support a head of the user seated on the seat,
wherein the hook and loop fasteners are capable of coupling the head support platform to the base in one or more positions, a position of the one or more positions enabling placement of the head of the user between the pair of cushioned members of the head support platform.

2. The head support structure of claim 1, wherein the base is coupled to a headrest of the seat through a coupling mechanism, the coupling mechanism comprising at least one of snap hooks, clips, buttons, strings and buckles.

3. The head support structure of claim 1, wherein the base is composed of at least one of cotton, nylon, polyester and leather.

4. The head support structure of claim 1, wherein the head support platform is composed of at least one of cotton, nylon, polyester and leather.

5. The head support structure of claim 1, wherein a shape of the base is rectangular.

6. The head support structure of claim 5, wherein a length dimension of the rectangular base is about 12 inches and a breadth dimension of the rectangular base is about 10 inches.

7. The head support structure of claim 1, wherein a shape of the head support platform is square.

8. The head support structure of claim 7, wherein each side of the square head support platform is about 10 inches.

9. The head support structure of claim 1, wherein a height of each cushioned member of the pair of cushioned members is in a range of about 2 to 3 inches.
